(19) United States
(12) Patent Application Publication
(10) Pub. No.: US 2008/0212152 A1
(43) Pub. Date: Sep. 4, 2008

(54) SYSTEM AND METHOD FOR ENCRYPTION OF A HOLOGRAPHIC IMAGE

(76) Inventors: Scott Lerner, Corvallis, OR (US); Kuohua (Angus) Wu, Corvallis, OR (US); Stephan R. Clark, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/681,114

(22) Filed: Mar. 1, 2007

(51) Int. Cl. G02B 5/32

(52) U.S. Cl. 359/21; 359/2

(57) ABSTRACT

A system and method for encryption of a holographic image is disclosed. The method includes the operation of producing a beam of light having at least two wavelengths of light. The beam of light can be split to form an illumination beam and a reference beam. Amplitude information can be added to the illumination beam with an intensity control device to form an object beam. Wavelength information can be selected in the object beam to form a spatial color modulated object beam. The reference beam and spatial color modulated object beam can be directed to a predetermined location on the holographic media to interfere to record an interference pattern.

### BACKGROUND

A three dimensional image of an object or scene can be recorded by storing the amplitude and phase information using diffraction of coherent light. Such a recording is typically referred to as a hologram. FIG. 1 shows a standard method for recording a holographic image. A coherent light beam 102 can be split (using, for example, a beam splitter 104) into an illumination beam 106 and a reference beam 108. The illumination beam and reference beam remain substantially coherent. The illumination beam is used to illuminate an object 110. An object beam 112 is reflected from the illuminated object. The object beam and reference beam combine at a photographic plate 114. Optical interference between the reference beam and the object beam, due to the superposition of the light waves, produces a series of intensity fringes that can be recorded on a photographic media such as standard film. These fringes form a type of diffraction grating on the film, which is called the hologram.

Once the film is processed, if illuminated again with the reference beam, diffraction from the fringe pattern on the film reconstructs the original object beam in both intensity and phase. Because both phase and intensity are reproduced, the image appears three-dimensional. The viewer can move his or her viewpoint and see the image rotate as the original object would.

Certain types of holograms, known as reflection holograms, can be viewed under an ordinary white light source. Reflection holograms are often used as security features to authenticate important documents or information. For example, packaging for authentic operating system software may include a reflection hologram to show that the software has not been illegally copied. Many credit cards contain reflection holograms to allow customers and retailers to be assured that the cards are original. Holograms are used due to the difficulty in their reproduction.

One method for reproducing a hologram is by using photomasks in a process similar to microchip formation. Another method is by embossing of surface relief holograms. For example, an original hologram can be formed on a glass plate with a fringe pattern comprising several thousand lines per inch, with each fringe having less than 1 micron depth. Molds of the original hologram can be made and used to form stamps to make duplicate images.

The complexity and cost of forming and mass producing holograms has limited the use of security holograms in common business and security practices. Recently, however, improvements in imaging and printing have allowed holograms to be directly printed using laser type printing devices. The hologram laser printing devices, however, have been limited to printing amplitude information. An amplitude only hologram suffers from the same problems as a typical photograph, appearing two dimensional. Additionally, such amplitude only holograms can be copied and reproduced fairly easily. The ease of reproduction of amplitude only holograms produced with hologram laser printers has reduced the desirability of using holograms created in this fashion for security purposes.

### BRIEF DESCRIPTION OF THE DRAWINGS

FIG. 1 is an illustration of a prior art method for forming a hologram;

FIG. 2 is an illustration of a system for encrypting a holographic image with a spatial color modulator, in accordance with an embodiment of the present invention;

FIG. 3 is an illustration of a spatial color modulator in accordance with an embodiment of the present invention.

FIG. 4 is an illustration of a system for encrypting a holographic image using a spatial light modulator and a spatial color modulator, in accordance with an embodiment of the present invention;

FIG. 5 is an illustration of a system for encrypting a holographic image using a spatial color modulator at both the object beam and the reference beam, in accordance with an embodiment of the present invention; and

FIG. 6 is a flow chart depicting a method for encrypting a hologram in accordance with an embodiment of the present invention.

### DETAILED DESCRIPTION OF EXAMPLE EMBODIMENTS

Reference will now be made to the exemplary embodiments illustrated, and specific language will be used herein to describe the same. It will nevertheless be understood that no limitation of the scope of the invention is thereby intended.

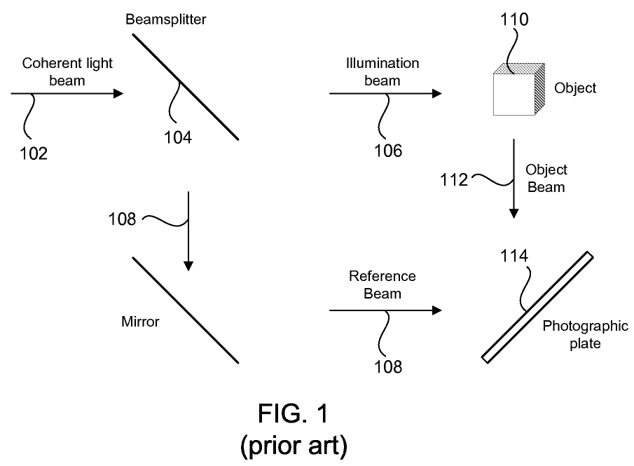

When a hologram is generated using standard analog printing techniques, as shown in FIG. 1, a three dimensional image is generated due to a phase difference between the object beam 112 and the reference beam 106. The phase difference is created by the difference in path length between the two beams. The illumination beam is reflected off of the three dimensional surface of the object. The reflected coherent light from the object 110 then combines with the reference beam 106 at the photographic plate 114. The difference in phase between the two beams of coherent light causes interference patterns which are stored on the photographic plate.

Analog printing, as used in this application, refers to the process of printing an entire page using a fixed format. For example, a newspaper is typically printed using analog printing, in which a printing press employs plates that are used to print each page. The image on the page cannot be changed due to the fixed plates used to print the image. Holograms are typically created in an analog fashion, in which the hologram is created by illuminating the entire photographic plate with the reference beam and the object beam. Copies of holograms are also created in an analog process, typically using a stamping or photomask process to create a holographic image.

In accordance with one aspect of the invention, it has been recognized that a system and method is needed to digitally print a hologram that can be used to authenticate a document. In one embodiment, the present invention provides a system and method for encrypting a holographic image using a spatial color modulation key. The key essentially scrambles the holographic image such that it typically cannot be viewed without the use of the key.

Spatial color modulation encrypted holographic images can be used to authenticate documents, objects, or information as being genuine. An individual receiving a document or object that has an encrypted holographic image affixed can use a key to reveal that an intended holographic image is contained in the encrypted image. Alternatively, the encrypted holographic image can be used as a physical means for encrypting information contained within the image. For example, the holographic image can include proprietary information which is then scrambled using the spatial color modulator. The proprietary information can be retrieved by an individual having the key. This will be explained more fully below.

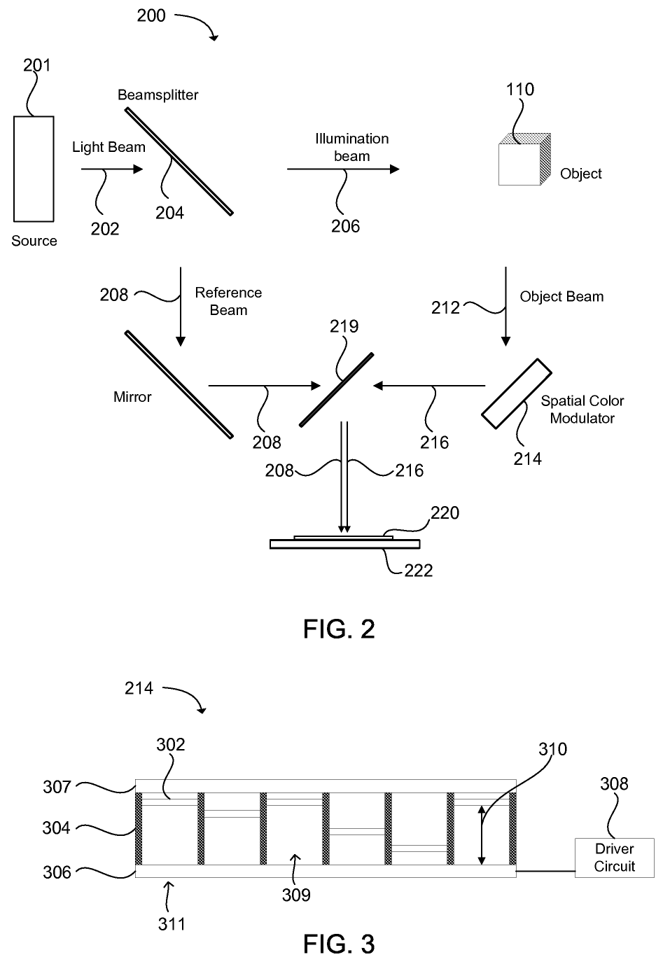

FIG. 2 is an illustration of a system for encrypting a holographic image with a spatial color modulator, in accordance with an embodiment of the present invention. The system 200 includes a source 201 for a light beam 202. The light beam can include at least two wavelengths. For example, the light beam can be produced using two or more laser light sources. Alternatively, the light source may be a high intensity white light source, such as a xenon lamp, a mercury arc lamp, an LED source, a broadband white LED source, a photonic lattice LED source, and the like.

The light beam can be directed to a beamsplitter 204. The beamsplitter can be any device capable of splitting the light beam. The light beam can be split such that substantially even intensities of light are divided among an illumination beam 206 and a reference beam 208. Alternatively, the light beam can be divided unevenly.

The illumination beam 206 can be directed toward an intensity control device, such as the object 110. The illumination beam can be reflected from the object to form an object beam 212, with amplitude and phase information from the object recorded within the object beam as previously discussed.

The object beam 212 can be directed from the object 110 to a spatial color modulator 214. The spatial color modulator 214 can be a Fabry Perot filter, a Fabry Perot etalon, a dielectric stack filter, and the like. For example, the spatial color modulator can be comprised of an array of color selection modules 311, as shown in FIG. 3. Each color selection module can include a slidable mirror 302 carried by supporting arms 304. The supporting arms can bias the mirror to a primary position. The primary position can be at the top or bottom of the cavity 309. The height 310 of the slidable mirrors can be adjusted using a driver circuit 308 to apply a voltage between the mirror and a base 306 or 307. Applying a voltage can create an attractive electrostatic charge that draws each mirror towards the base over a predetermined distance, enabling the size of the cavity 309 to be selected. A driver control means can be stored on a computer readable medium.

In one embodiment, the base 306, 307 can include a partially reflective mirror and each slidable mirror 302 can include a substantially fully reflective surface. With the mirrors spaced at approximately ½ wavelength, light can be reflected 0 times, 2 times, 4 times, and so forth. When the light interferes, a relatively narrow wavelength of light is produced within the cavity. The size of the cavity 309 can be adjusted by moving the slidable mirror up or down using the driver 308. The size of the cavity can be designed to be resonant for a specific wavelength. Thus, each cavity can be configured to select a certain wavelength that is in the beam of light directed on the cavity.

The spatial color modulator 214 can be comprised of a two dimensional array of color selection modules 311. The array can include tens, hundreds, or thousands of modules on each side. For example the array may include 1080 modules by 1920 modules for over 2 million separate color selection modules. The spatial color modulator is not constrained to function as previously described. Rather, the spatial color modulator can be constructed from substantially any active color filter that is capable of electrically or mechanically spatially filtering selected wavelengths of light from the object beam 212 (FIG. 2).

Returning to FIG. 2, the spatial color modulator 214 can output a spatial color modulated object beam 216 that includes hundreds, thousands, or millions of separate color beams, with each beam having a selected wavelength from the object beam 212. The spatial color modulated object beam can be directed 219 toward the holographic media 220. The reference beam 208 can also be directed to a substantially similar location on the holographic media. The directing means used to direct the spatial color modulated object beam and the reference beam to a substantially similar location on the holographic media can include one or more mirrors or lenses, as can be appreciated.

Each of the color beams in the spatial color modulated object beam 212 can interfere with a corresponding wavelength within the reference beam 208 to form an amplitude-phase interference pattern on the holographic media 220. The interference pattern can then be recorded within the holographic media to form an encrypted holographic image. Thus, the interference pattern for each of the color beams is related to the wavelength of the beam. The encrypted holographic image can appear substantially as visual noise.

In order to view an image of the object 110 in the encrypted holographic image, a light beam 202 from the light source 201 can be directed on the encrypted holographic image and to the spatial color modulator 214. The spatial color modulator can act as a key. If each of the color selection modules 311 (FIG. 3) within the spatial color modulator have the same setting as when the hologram was formed, the output of the spatial color modulator will be a three dimensional holographic image of the object 110.

Accordingly, an electronic or digital key can be used to form an encrypted holographic image. The key can be based on an algorithm, a desired pattern, or some other means for determining the wavelength output of each of the color selection modules 311 (FIG. 3). The electronic key can include the information used by the driver circuit 308 (FIG. 3) to control the spatial color modulator 214. To replicate an image of the object, the same information can be used to enable each of the color selection modules to have substantially the same setting as when the holograph was formed, as previously described. The electronic key can be transmitted, hand carried, or otherwise sent to a recipient of the encrypted hologram. The recipient can use a holographic image encryption system 200, or a similar system having a spatial phase modulator that can be setup with the electronic key. A recipient can use the properly setup spatial color modulator to view an encrypted holographic image to authenticate that the object, document, or information affixed to or associated with the holographic image is genuine.

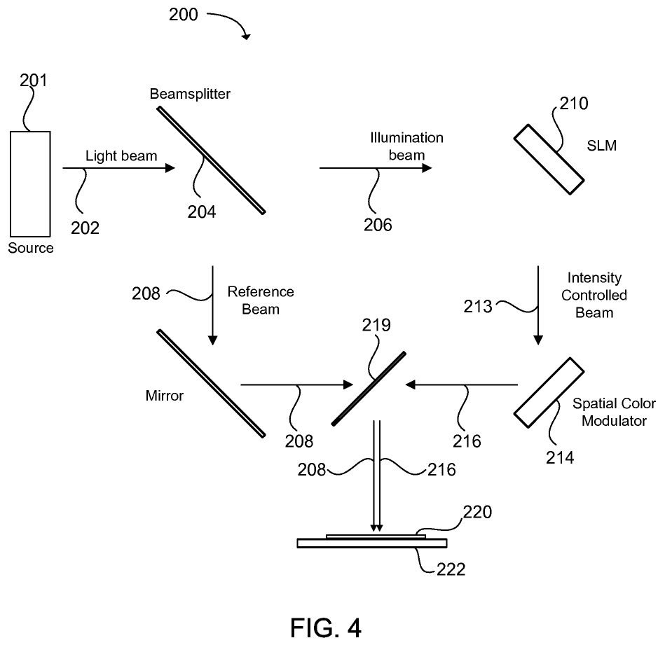

In another embodiment, the intensity control device can be a spatial light modulator (SLM) 210, as shown in FIG. 4. The SLM can be a two dimensional array of mirrors, each configured to control an intensity of the beam. The SLM can be used in place of an object 110 (FIG. 2). Rather than directing the illumination beam toward the object, the illumination beam can be sent to the SLM. The SLM can be used to add amplitude information to the illumination beam 206 to form an intensity controlled beam 213. The intensity controlled beam can then be directed from the SLM toward the spatial color modulator 214, as previously described.

The use of an SLM 210 allows digital images or information to be recorded on the holographic media 220. For example, a digital picture or an image containing text can easily be generated using an SLM. One drawback to using an SLM, however, is that the resulting holographic image will only be a two dimensional amplitude hologram since the intensity controlled beam 213 substantially lacks any phase information. However, the ability to project digital images may be desired in creating encrypted holographic images.

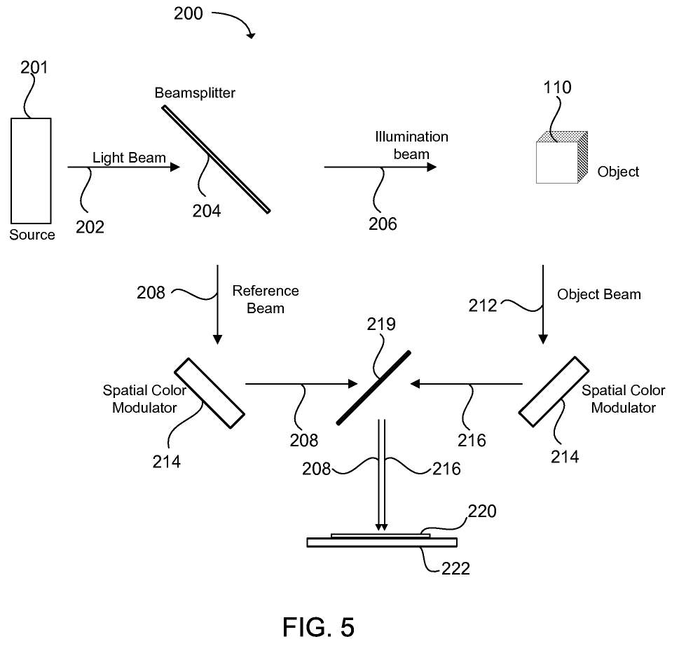

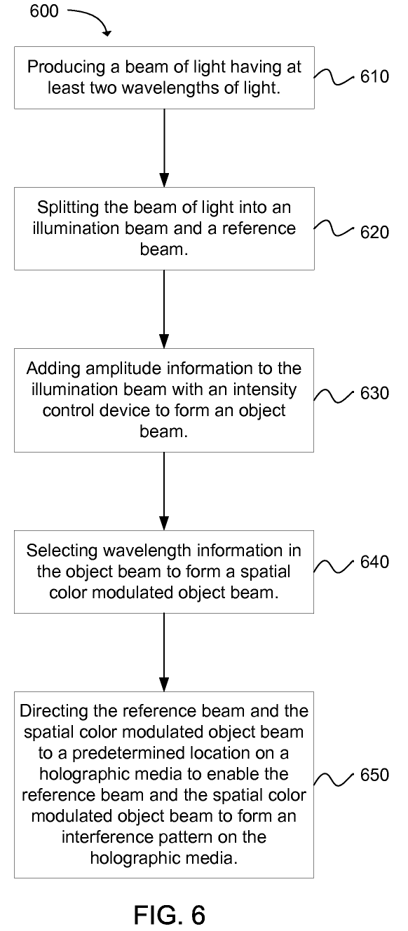

In another embodiment, an additional spatial color modulator 214 can be placed within the path of the reference beam 208, as shown in FIG. 5. The same key can be used on the spatial color modulator in the path of the reference beam and the spatial color modulator in the path of the object beam 212 or intensity control beam 213 (FIG. 4). Each spatial color modulator can output nearly identical color beams. The color beams can then be substantially aligned on the holographic media 220 where they can interfere to produce an interference pattern that can be recorded in the media.

The holographic media 220 can be any type of light sensitive media capable of recording the interference pattern. Examples of typically holographic media include silver halide film, Omnidex™ manufactured by Dupont™, and other types of photographic emulsions, dichromated gelatin, photoresists, photothermoplastics, photopolymers, photochromics, and photorefractives.

The amount of optical power needed to record a hologram onto the holographic media 220 is dependent upon the type of holographic media used and the length of exposure. For example, a pen type solid state laser may be sufficient to record a hologram onto silver halide film. However, much more power is required to record a hologram using photopolymers and photothermoplastics. One or more pulsed gas lasers or high amplitude white light sources such as mercury vapor lamps may be used to obtain sufficient power to record a hologram in the holographic media within an acceptable time frame.

The holographic media 220 can be carried by a backing 222, such as a paper, plastic, metal, or glass. The backing can be used to provide support to the holographic media. The backing can also provide a medium for printing additional information. For example, an identification card may be comprised of a paper or plastic backing upon which information is included. A portion of the card can include a holographic media carried by the card backing. The holographic image encryption system 200 can be used to print an encrypted amplitude hologram or an encrypted phase-amplitude hologram onto the holographic media. A traditional printer, such as a laser printer or inkjet printer, can be used to print additional information on the backing. The holographic printing system and a traditional printing system can be included in a single device configured to print on both the backing and the holographic media.

In one embodiment, an encrypted hologram can be printed on the holographic media 220 by illuminating the entire holographic media at one time with the spatial color modulated object beam 216 and the reference beam 208 for a period sufficient to allow an interference pattern to be recorded.

In another embodiment, the spatial color modulated object beam 216 and reference beam 208 can be directed to cover a selected portion of the holographic media 220. The remaining media can be covered to prevent it from being exposed. Multiple selected portions of the media can be sequentially exposed to allow the spatial color modulated object beam and reference beam to be directed to the desired areas of the holographic media.

Unlike traditional printing methods, where different subsections of an image are printed in the correct location to provide a complete image, creating a larger or more detailed hologram can be accomplished by recording the same holographic information (interference pattern) on the holographic media two or more times, as can be appreciated. Thus, a larger and/or more detailed hologram can be created by focusing the spatially controlled beam and reference beam to illuminate a portion of the holographic media, recording the interference pattern within the portion, and moving the media or beams to record one or more additional sections of the media with substantially the same interference pattern to form a larger holographic image or an image having more information.

The holographic image encryption system 200 can be incorporated within a variety of different types of printers. In one embodiment, the holographic image encryption system can be included in a laser printer. Other types of printers which can be used in conjunction with the image encryption system include inkjet printers, bubble jet printers, liquid-electro-photographic printers, and the like.

In another embodiment, a method 600 for encrypting a hologram is disclosed. The method includes the operation of producing 610 a beam of light having at least two wavelengths of light. A greater number of different wavelengths within the light enables a more complex key. An additional operation provides splitting 620 the beam of light into an illumination beam and a reference beam. Amplitude information can be added 630 to the illumination beam with an intensity control device to form an object beam. The intensity control device can be an object or a spatial light modulator or similar type device capable of adding amplitude information and/or phase information to the illumination beam. The amplitude information can be positive or negative, resulting in a net change to a portion of the illumination beam.

The method further provides selecting 640 wavelength information in the object beam to form a spatial color modulated object beam. The wavelength information can be added using a spatial color modulator, as previously described. The spatial color modulator can include a plurality of color selection modules. A greater number of color selection modules can produce a key having greater complexity.

The color selection modules can be used to filter a wavelength of light from the object beam and output that wavelength. In one embodiment, each separate wavelength that is output can be at least 10 nm in wavelength apart. For example, output wavelengths can be 400 nm, 410 nm, 420 nm, and so forth. The maximum difference in wavelength is dependent on the type of holographic media used to record the encrypted holographic image. For instance, the selected holographic media may only record wavelengths from 700 nm to 400 nm. Light outside of that band would not be recorded. Obviously, the type of media used can be coordinated with the wavelengths selected using the spatial color modulator.

An additional operation of the method provides directing 650 the reference beam and the spatial color modulated object beam to a predetermined location on a holographic media to enable the reference beam and the spatial color modulated object beam to form an interference pattern on the holographic media, as previously described.

The holographic media can be used to record the interference patterns. For example, Omnidex™ can be used to record the interference patterns. Omnidex™ is a photopolymer that can be treated with ultraviolet light and heat after it has been illuminated with the interference pattern. The interference pattern changes the index of refraction of the photopolymer based on the intensity of exposure. The index changes the speed of light as it travels through the photopolymer, enabling a user to view a three dimensional holographic image that was recorded.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for encrypting a holographic image, comprising
producing a beam of light having at least two wavelengths of light;
splitting the beam of light into an illumination beam and a reference beam;
adding amplitude information to the illumination beam with an intensity control device to form an object beam;
selecting wavelength information in the object beam to form a spatial color modulated object beam; and
directing the reference beam and the spatial color modulated object beam to a predetermined location on a holographic media to enable the reference beam and the spatial color modulated object beam to form an interference pattern on the holographic media.

2. A method as in claim 1, wherein selecting wavelength information further comprises directing the object beam to a spatial color modulator having an array of color selection modules, wherein each color selection module is configured to select one of the at least two wavelengths from the object beam.

3. A method as in claim 2, further comprising directing the object beam to a spatial color modulator having a two dimensional array of color selection modules.

4. A method as in claim 2, further comprising directing the object beam to a spatial color modulator selected from the group consisting of a Fabry Perot filter, a Fabry Perot etalon, and a dielectric stack filter.

5. A method as in claim 2, further comprising controlling the spatial color modulator with a driver electrically coupled to the spatial color modulator, the driver configured to provide a sufficient voltage between a base and a slidable mirror within at least one of color selection modules to change a height of the mirror relative to the base based on an electrostatic charge induced by the voltage.

6. A method as in claim 1, wherein adding amplitude information to the illumination beam further comprises directing the illumination beam to be reflected from a predetermined object to form the object beam.

7. A method as in claim 1, wherein adding amplitude information to the illumination beam further comprises adding amplitude information to the illumination beam using a spatial light modulator to form the object beam.

8. A method as in claim 2, further comprising directing the reference beam to a reference spatial color modulator that is synchronized with the spatial color modulator to enable the reference beam to have substantially similar wavelength information as the spatial color modulated object beam.

9. A method as in claim 1, further comprising forming the interference pattern on the holographic media configured to record the interference pattern, wherein the holographic media is selected from the group consisting of photographic emulsions, dichromated gelatin, photoresists, photothermoplastics, photopolymers, photochromics, and photorefractives.

10. A system for encryption of a holographic image, comprising:
a light source for a beam of light having at least two wavelengths of light;
a beam splitter configured to split the beam of light into an illumination beam and a reference beam;
an intensity control device configured to add amplitude information to the illumination beam to form an object beam;
a spatial color modulator configured to add wavelength information to the object beam to form a spatial color modulated object beam;
an optical redirection device for directing the spatial color modulated object beam and the reference beam to a predetermined location on a holographic media to enable the reference beam and spatial color modulated object beam to form an interference pattern on the holographic media.

11. A system as in claim 10, wherein the spatial color modulator is configured of a two dimensional array of color selection modules configured to output a selected wavelength of light from the object beam.

12. A system as in claim 10, wherein the intensity control device is a spatial light modulator configured to add amplitude information to the illumination beam to form an intensity controlled beam.

13. A system as in claim 10, wherein the intensity control device is an object selected to reflect the illumination beam to add amplitude and phase information to the illumination beam to form the object beam.

14. A system as in claim 10, further comprising a reference spatial color modulator configured to select wavelength information in the reference beam to form a spatial color modulated reference beam.

15. A system as in claim 14, wherein the spatial color modulated object beam and the spatial color modulated reference beam are aligned on the holographic media to enable the spatial color modulated object beam and the spatial color modulated reference beam to interfere to form an interference pattern on the holographic media.

16. A system for encryption of a holographic image, comprising:
a means for producing a beam of light having at least two wavelengths of light;
a means for splitting the beam of light into an illumination beam and a reference beam;
a means for adding amplitude information to the illumination beam to form an object beam;
a means for selecting wavelength information in the object beam to form a spatial color modulated object beam; and
a means for directing the reference beam and the spatial color modulated object beam to a predetermined location on a holographic media to enable the reference beam and the spatial color modulated object beam to form an interference pattern on the holographic media.

17. A system as in claim 16, further comprising a covering means for covering a portion of the holographic media to enable the holographic media to be exposed a plurality of times at an uncovered portion of the holographic media.

18. A method of making a holographic printer configured to print an encrypted hologram, comprising:
providing a light source configured to emit a light beam having at least two wavelengths;
positioning a light dividing means configured to split the light beam into a reference beam and an illumination beam;
positioning an intensity control device configured to add amplitude information to the illumination beam to form an object beam;
locating a spatial color modulator in a path of the object beam to form a spatial color modulated object beam;
situating a beam redirection means in a path of at least one of the spatial color modulated object beam and the reference beam to direct the reference beam and the spatial color modulated object beam to a substantially similar location on a holographic media to form an interference pattern on the holographic media.

19. A method of making as in claim 18, wherein positioning an intensity control device further comprises positioning a spatial light modulator configured to add amplitude information to the illumination beam to form an object beam.

20. An article of manufacture comprising:
a computer readable medium having computer readable program code means embodied therein for causing a printer to print an encrypted digital hologram, the computer readable program code means in said article of manufacture comprising:
computer readable code means for causing a light source to transmit a light beam having at least two wavelengths directed toward a splitting means, wherein the splitting means is configured to split the light beam into a reference beam and an illumination beam, the reference beam being directed toward a holographic media and the illumination beam being directed toward an intensity control device followed by a spatial color modulator comprising a two dimensional array of color selection modules, wherein a plurality of the color selection modules have an adjustable cavity size; and
computer readable code means for causing a computer to control a driver circuit, the driver circuit being electrically coupled to the spatial color modulator, wherein the driver circuit is configured to vary a voltage between a plurality of slidable mirrors and a base to provide an electrostatic charge sufficient to change a cavity size in each of the plurality of color selection modules to select a wavelength of an object beam to form a spatial color modulated object beam, wherein the spatial color modulated object beam is directed toward the holographic media to interfere with the reference beam and form an interference pattern on the holographic media.
